(19) United States
(12) Patent Application Publication
(10) Pub. No.: US 2016/0067726 A1
(43) Pub. Date: Mar. 10, 2016

(54) PRESSURE WASHER SPRAY GUN WITH GRIP SENSOR

(71) Applicant: Briggs & Stratton Corporation, Wauwatosa, WI (US)

(72) Inventors: Richard Gilpatrick, Whitewater, WI (US); Robert Koenen, Pewaukee, WI (US); Dan Klika, Waukesha, WI (US)

(73) Assignee: Briggs & Stratton Corporation, Wauwatosa, WI (US)

(21) Appl. No.: 14/845,034

(22) Filed: Sep. 3, 2015

Related U.S. Application Data
(60) Provisional application No. 62/045,781, filed on Sep. 4, 2014.

(51) Int. Cl. B05B 9/04; B05B 9/00

(52) U.S. Cl. CPC B05B 9/0426; B05B 9/007

(57) ABSTRACT

A pressure washer includes a prime mover, a pump, and a spray gun. The spray gun including a handle with a first grip portion, a barrel including a second grip portion, a flow-control valve movable between an open position and a closed position, and a user interface to control the flow-control valve. A presence sensor is coupled to the second grip portion to detect the presence of the user's second hand. A first wireless system is electrically coupled to the presence sensor. A second wireless system is electrically coupled to the prime mover. The first wireless system transmits a start signal to the second wireless system when the presence sensor detects the presence of the second hand of the user. The second wireless system, upon receiving the start signal causes the prime mover to start operation.

### CROSS-REFERENCE TO RELATED PATENT APPLICATIONS

This application claims the benefit of U.S. Application No. 62/045,781, filed Sep. 4, 2014, which is incorporated herein by reference in its entirety.

### BACKGROUND

The present invention relates generally to the field of pressure washers.

The use of pressure washers with spray guns for cleaning and other tasks is well known. The water spray may be expelled from the spray gun at a relatively high pressure, resulting in a substantial reaction force on the spray gun. Without the use of both hands, a user of the pressure washer may have limited control of the spray gun.

### SUMMARY

One embodiment of the invention relates to a pressure washer. The pressure washer includes a prime mover, a pump driven by the prime mover, and a spray gun fluidly coupled to the pump. The spray gun including a handle with a first grip portion configured to be gripped by a first hand of a user, a barrel including a second grip portion configured to be gripped by a second hand of the user, and a flow-control valve movable between an open position and a closed position to control a fluid flow from the spray gun. The spray gun further includes a user interface configured to be operable by the first hand of the user and to control the flow-control valve such that in a first state of the user interface, the flow-control valve is in the closed position, and in a second state of the user interface, the flow-control valve is in the open position. The spray gun further includes a presence sensor coupled to the second grip portion and configured to detect the presence of the user's second hand, a first wireless system electrically coupled to the presence sensor, and a second wireless system electrically coupled to the prime mover. The first wireless system transmits a start signal to the second wireless system when the presence sensor detects the presence of the second hand of the user. The second wireless system, upon receiving the start signal causes the prime mover to start operation.

Another embodiment of the invention relates to a pressure washer including a prime mover, a pump driven by the prime mover, a spray gun fluidly coupled to the pump, the spray gun including a handle with a first grip portion configured to be gripped by a first hand of a user, a barrel including a second grip portion configured to be gripped by a second hand of the user, a flow-control valve movable between an open position and a closed position to control a fluid flow from the spray gun, a user interface configured to be operable by the first hand of the user and to control the flow-control valve such that in a first state of the user interface, the flow-control valve is in the closed position, and in a second state of the user interface, the flow-control valve is in the open position, a first presence sensor coupled to the first grip portion and configured to detect the presence of the user's first hand, a second presence sensor coupled to the second grip portion and configured to detect the presence of the user's second hand, and a first wireless system electrically coupled to the first and second presence sensors, and a second wireless system electrically coupled to the prime mover. The first wireless system transmits a start signal to the second wireless system when the first presence sensor detects the presence of the first hand of the user and the second presence sensor detects the presence of the second hand of the user. The second wireless system, upon receiving the start signal causes the prime mover to start operation.

Another embodiment of the invention relates to a pressure washer including a prime mover, a pump driven by the prime mover, a spray gun fluidly coupled to the pump, the spray gun including a handle with a first grip portion configured to be gripped by a first hand of a user, a barrel including a second grip portion configured to be gripped by a second hand of the user, a flow-control valve movable between an open position and a closed position to control a fluid flow from the spray gun, a user interface configured to be operable by the user to control the flow-control valve such that in a first state of the user interface, the flow-control valve is in the closed position, and in a second state of the user interface, the flow-control valve is in the open position, a presence sensor configured to actuated by the user, and a spray gun wireless system electrically coupled to the presence sensor, and a wireless starting system, wherein the spray gun wireless system is configured to transmit a start signal to the wireless starting system of the pressure when the presence sensor is actuated thereby starting the prime mover.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a rear perspective view of a pressure washer including multiple chemical tanks, according to an exemplary embodiment.

FIG. 2 is a side view of a spray gun for the pressure washer of FIG. 1, according to an exemplary embodiment.

FIG. 3 is a top view of the spray gun of FIG. 2.

FIG. 4 is a cross-section view of the spray gun of FIG. 3, taken along line 4-4.

FIG. 5 is a block diagram of a wireless communication system for the pressure washer of FIG. 1, according to an exemplary embodiment.

FIG. 6 is a flowchart of a method for remotely starting a pressure washer, according to an exemplary embodiment.

FIG. 7 is a flowchart of a method for remotely starting a pressure washer, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

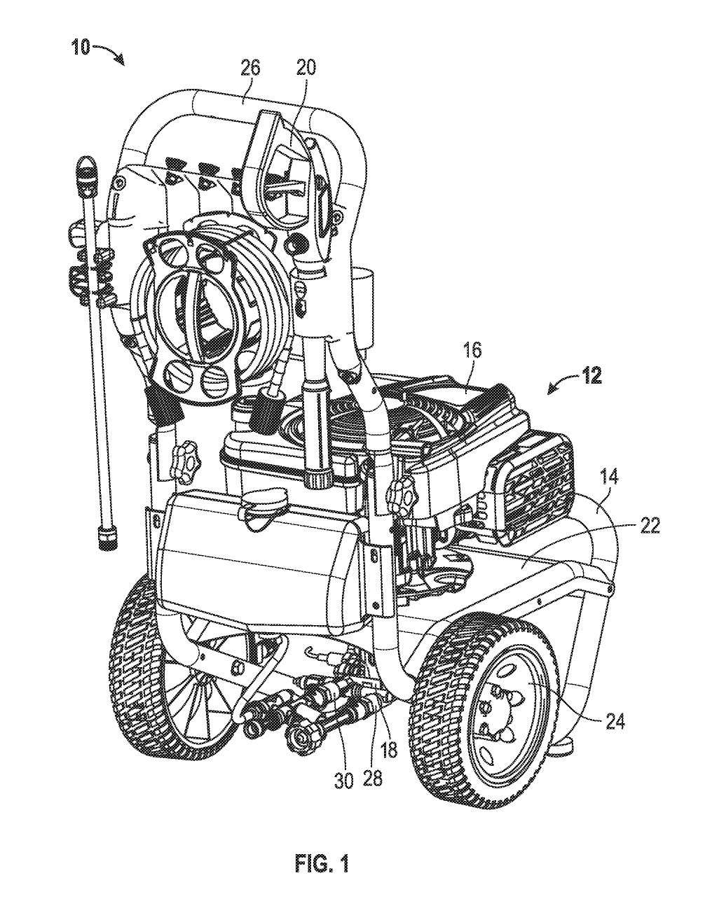

Referring to FIG. 1, a pressure washer 10 includes a base unit 12 with a frame 14 supporting a prime mover 16, such as an internal combustion engine or an electric motor, and a water pump 18 (e.g., positive displacement pump, piston water pump, axial cam pump). The pressure washer 10 further includes a spray gun 20 that is coupled to the water pump 18 with a delivery conduit 21 (e.g., a high-pressure hose). In other embodiments, an electric motor is used as the prime mover 16. In some embodiments, the prime mover 16 is fastened to the top of a base plate 22 of the frame 14 and the water pump 18 is mounted below the base plate 22 and connected to a power takeoff of the prime mover 16 via a hole through the base plate 22. In other embodiments, the water pump is directly coupled to and supported by the engine or prime mover. The water pump 18 is coupled (e.g., directly coupled, indirectly coupled by a transmission, belts, gears, or other drive system) to the prime mover 16 to be driven by the prime mover 16. In some embodiments, the pressure washer 10 is portable and includes wheels 24 and a handle 26. In other embodiments, the pressure washer 10 may be stationary. In other embodiments, the pressure washer 10 is mounted to a trailer or other vehicle. The water pump 18 includes a pump inlet 28 and a pump outlet 30. The pump inlet 28 is configured to be coupled to a supply conduit or hose, which is in turn connected to a fluid supply (e.g., a spigot connected to a municipal water supply or well). In some embodiments, the pump inlet 28 includes a low-pressure, garden-hose style fitting for coupling a garden hose to the pump inlet 28. The pump outlet 30 includes a high-pressure fitting (e.g., an M22 fitting) for coupling the pump outlet 30 to the delivery conduit 21 or other device including an appropriate high pressure fitting. As shown in FIG. 1, pressure washer 10 uses a vertical shaft engine. According to an alternative embodiment, the prime mover may be a horizontal shaft engine.

In some embodiments, the pressure washer 10 may further includes a chemical supply system that is configured to selectively introduce a liquid chemical into the water stream provided to the spray gun 20. The liquid chemical may be a detergent for cleaning various surfaces, a fertilizer for lawn care, a pesticide, an herbicide, etc.

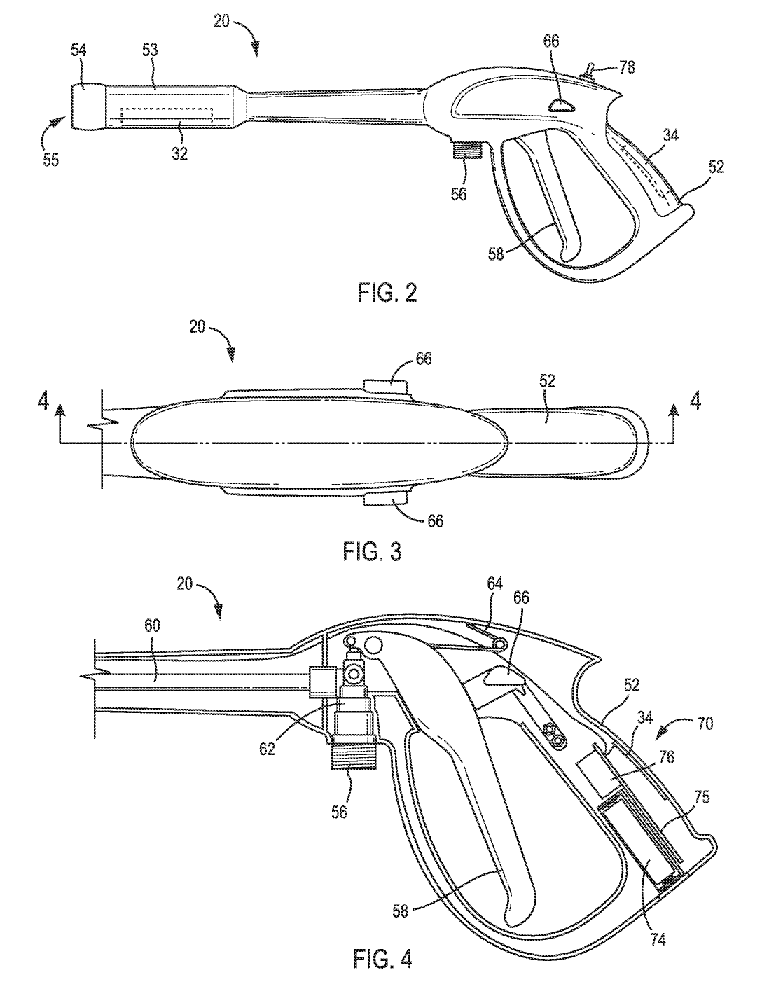

Referring now to FIG. 2, the spray gun 20 is shown according to an exemplary embodiment to include a handle 52 and a nozzle 54. High pressure water is provided to the spray gun 20 from the pump outlet 30 through the delivery conduit 21, which is coupled to the spray gun 20 via an inlet 56. The inlet 56 may be a threaded fitting, such as a high-pressure fitting (e.g., an M22 fitting). The stream of water output from the nozzle 54 can be started or stopped by a user using a trigger 58. The spray gun 20 allows the user to manage the direction of the stream of water independent of the location and orientation of the base unit 12 and the duration of the stream of water. In some embodiments, the nozzle 54 may be a variable nozzle that is capable of producing various patterns, pressures, and flow rates for the stream of water (e.g., the nozzle 54 may include a rotatable head 55 with multiple openings). In some embodiments, the nozzle 54 may receive one of multiple spray nozzles, each of which provide a different pattern, pressure, flow rate, etc. The spray gun 20 may be configured to be grasped with two hands, with one hand being placed on the handle 52 and a second hand being placed on a grip portion provided by a barrel 53, proximate the nozzle 54. The grasping of the spray gun 20 with two hands allows a user to have greater control of the stream of water expelled from the nozzle 54.

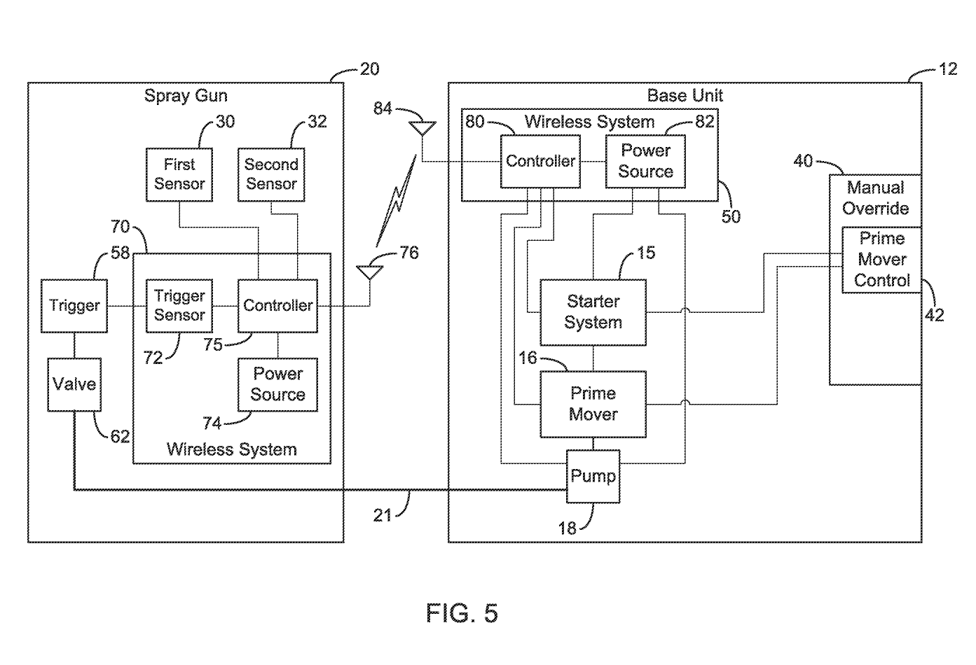

Referring now to FIG. 4, the internal components of the spray gun 20 are shown schematically according to an exemplary embodiment. The water passes from the inlet 56 to the nozzle 54 through an internal conduit 60. The passage of water is controlled by a flow-control valve 62 that is coupled to and controlled by the trigger 58 or other user input (e.g., trigger, button, switch, dial, touch screen, etc.). The flow control valve 62 is configured to be opened when the user pulls the trigger 58 towards the handle 52, allowing the water to flow through the conduit 60 to be expelled through the nozzle 54, and closed when the trigger 58 is released. The trigger 58 may be biased towards the closed position by a biasing element, shown in FIG. 5 as a torsion spring 64. The spray gun 20 may further include a locking device to prevent the trigger 58 from being inadvertently pulled. According to an exemplary embodiment, the locking device is provided in the form of a locking switch 66. The locking switch 66 has a locked position in which it disposed along the path of the trigger 58. The locking switch 66 extends out of either side of the spray gun 20 proximate the handle 52. The user can push the locking switch 66 out of the locked position by depressing the switch 66 from either side (e.g., with the thumb), allowing the trigger 58 to be pulled. The ability for the locking switch 66 to be unlocked from either side allows the spray gun 20 to be used in either hand. The locking switch may be biased towards the locked position. The trigger 58 may be configured to engage the locking switch 66 in the unlocked position such that a user may keep the locking switch 66 in the unlocked position by keeping the trigger 58 pulled back, thereby reducing the strain of applying a continuous pressure on the locking switch 66. Releasing the trigger 58 may disengage it from the locking switch 66, allowing the locking switch 66 to return to the locked position and requiring the user to move the locking switch 66 back to the unlocked position to allow the trigger 58 to be pulled again.

The pressure washer 10 further includes at least one sensor configured to detect the presence of a user's hand on the spray gun 20. The sensor is positioned to encourage a user to use two hands on the spray gun 20. According to some embodiments, a first sensor 32 is positioned to detect the presence of the user's hand on a barrel 53 of the spray gun 20 through which the conduit 60 passes.

The sensors 32 and 34 may be any appropriate sensors that are capable of reliably detecting the presence of a user's hand. In one embodiment, the sensors 32 and 34 may be a contact switch, such as capacitive switch or a resistance touch switch. In another embodiment, the sensors 32 and 34 may be mechanical pressure-sensitive switches.

In some embodiments, a second sensor 34 is positioned to detect the presence of a user's hand on the handle 52 of the spray gun 20. In other embodiments, one or more of the sensors 32 and 34 may be provided in a variety of locations to determine the presence of the user's hands. For example, in another embodiment, the sensor 34 may be provided in the trigger 58 instead of in the handle 52. The pressure washer system 10 may include sensors 34 in both the handle 52 and the trigger 58 such that the pressure washer system 10 may detect the presence of the user's hand on the handle 52 in addition to the presence of the user's hand on the trigger 58 and differentiate between the two states. One or more sensors 32 may be provided at any location on the barrel 53.

Referring now to FIG. 5, a block diagram of the pressure washer system 10 is shown according to an exemplary embodiment. The spray gun 20 includes a wireless system 70 that allows the spray gun 20 to communicate with a wireless system 50 provided on the base unit 12, to control components of the pressure washer 10 such as the prime mover 16 or a chemical supply system. The wireless system 70 includes a power source 74, a controller 75 (e.g., circuit board, control circuitry, etc.), and a transceiver 76 with which the wireless system 70 communicates with the wireless system 50. The wireless system 50 includes a controller 80 (e.g., circuit board, control circuitry, etc.), a power source 82, and a transceiver 84 with which the wireless system 50 communicates with the wireless system 70. It should be noted that, while the spray gun 20 is shown as communicating with the base unit 12 wirelessly with the wireless systems 50 and 70, in other embodiments the spray gun 20 may communicate with the base unit 12 with a wired connection (e.g., utilizing transmission along a wire or other conductive member running along the hose extending between the spray gun 20 and the base unit 12.

In some embodiments, the controllers 75 and 80 may each include a processor and a memory device. The processor can be implemented as a general purpose processor, an application specific integrated circuit (ASIC), one or more field programmable gate arrays (FPGAs), a group of processing components, or other suitable electronic processing components. The memory device (e.g., memory, memory unit, storage device, etc.) is one or more devices (e.g., RAM, ROM, Flash memory, hard disk storage, etc.) for storing data and/or computer code for completing or facilitating the various processes, layers and modules described in the present application. The memory device may be or include volatile memory or non-volatile memory. The memory device may include database components, object code components, script components, or any other type of information structure for supporting the various activities and information structures described in the present application. According to an exemplary embodiment, the memory device is communicably connected to the processor via the processing circuit and includes computer code for executing (e.g., by processing circuit and/or processor) one or more processes described herein.

In another exemplary embodiment, the controllers 75 or 80 may be implemented as non-programmable circuitry, one or more circuit boards, or one or more linear circuits. “Non-programmable circuitry” consists of analog or digital hard circuitry that does not utilize a microcontroller or software. It is believed that embodiments in which the controllers 75 or 80 are implemented as non-progammable circuitry including discrete components may be less expensive than embodiments implemented with microcontrollers or using software. Such non-programmable circuitry embodiments do not include a microcontroller. Non-programmable circuitry may include multiple discrete components that implement the various operations described herein.

According to an exemplary embodiment, the wireless system 70 of the spray gun 20 communicates with the wireless system 50 of the base unit 12 with low power, short range wireless RF communication. RF technology is relatively inexpensive compared to other wireless communication options (e.g., Bluetooth, WiFi, etc.). Unlike infrared technology, RF transceivers do not require line-of-sight and are omni-directional so that the spray gun 20 need not be pointed at the base unit 12 to establish communication.

In one embodiment, when the presence of one of the user's hands is detected on the spray gun 20, such as by the sensor 34 detecting the presence of the user's hand on the barrel 53, a signal is sent by the transceiver 76 to the transceiver 84 of the base unit wireless system 50. The signal instructs the controller 80 of the wireless system 50 to activate the starter system 15 to start the prime mover 16. The pressure washer system 10 may operate in a bypass mode such that the prime mover 16 is activated without providing a pressurized water stream to the spray gun 20. The wireless system 70 therefore allows the user to easily start the prime mover 16 from the spray gun 20 without having to be near the base unit 12. The wireless system 70 may include a start delay. The start delay postpones starting the prime mover 16 until the sensor 32 has detected the user's hand for a predetermined period of time (e.g., 1 sec.). A user may therefore briefly grip the barrel 53 either intentionally or unintentionally without causing the prime mover 16 to stop and start repeatedly.

In some embodiments, the wireless system 70 may further include a trigger sensor 72. The pressure washer system 10 may continue to operate the pump 18 in the bypass mode until the trigger is pulled, as detected by the trigger sensor 72 and the presence of a hand on the barrel 53 is detected with the sensor 34. The trigger sensor 72 may be a simple device, such as a switch that completes a circuit when the trigger 58 is pulled and/or when the locking switch 66 is moved from the locked position. Alternatively, the trigger sensor 72 may be omitted, and the pressure washer may switch out of bypass mode based on the start of flow from the spray gun 20 in response to opening the flow control valve 62.

In another embodiment, flow may be initiated by a signal from a valve position sensor monitoring the position of the flow control valve 62. When the valve position sensor detects that the flow control valve 62 has been opened by the trigger 58 being pulled, a signal is sent by the transceiver 76 to the transceiver 84 of the base unit wireless system 50. The signal instructs the controller 80 of the wireless system 50 to release the pressure washer system 10 from the bypass mode such that the pump 18 provides a pressurized water stream to the spray gun 20.

In another embodiment, the pressure washer system 10 may be configured to detect the presence of both hands on the spray gun 20 using the sensors 32 and 34. When the presence of both of the user's hands is detected on the spray gun 20, by the sensor 32 detecting the presence of the user's hand on the barrel 53, and by the sensor 34 detecting the presence of the user's hand on the handle 52, a signal is sent by the transceiver 76 to the transceiver 84 of the base unit wireless system 50. The signal instructs the controller 80 of the wireless system 50 to activate the starter system 15 to start the prime mover 16. With the presence of only one hand on the spray gun 20 detected by the sensors 32 or 34, the starter system 15 does not start the prime mover 16.

The wireless system 70 therefore allows the user to easily start the prime mover 16 from the spray gun 20 without having to be near the base unit 12 by grasping the spray gun with one or both hands. By placing a single sensor (e.g., sensor 32 on barrel 53) or two sensors (e.g., sensor 32 on barrel 53 and sensor 34 on handle 52) the likelihood increases that the user has full control of the spray gun 20 (i.e., the spray gun gripped with two hands) before pressurized water is provided to the spray gun 20.

The controller 80 monitors the starter system 15 and disengages the starter system 15 once it is determined that the prime mover 16 has been started. According to an exemplary embodiment, the controller 80 monitors the rotational speed of the prime mover, such as by monitoring the spark signal. Once the rotational speed reaches a predetermined threshold indicating the prime mover 16 has started, the controller 80 stops the starter system 15.

According to an exemplary embodiment, the wireless system 70 sends a continuous signal to the base unit 12 to keep the prime mover 16 running The user may stop the prime mover 16 in various ways. Once a criteria is met, such as by releasing the trigger 58 and/or releasing one or both hands from the spray gun 20 thereby disengaging one or more of the sensors 32 and 34, the signal to the base unit 12 for the prime mover 16 ceases and the prime mover 16 stops running In one embodiment, the wireless system 70 may include a stop delay timer. The delay allows the trigger 58 to be released or one hand to be removed from the spray gun 20 for a predetermined period of time (e.g., 5, 10, 15 seconds, etc.) before the prime mover 16 is stopped. While the stop delay timer is running, the pump 18 operates in a bypass or recirculation mode. A user may therefore release the trigger 58 either intentionally (e.g., to switch the spray gun between hands, to readjust the hand on the trigger 58, etc.) or unintentionally without causing the prime mover 16 to stop. When the prime mover 16 is an engine, the engine speed may be reduced to an idle speed from the normal operating speed while the stop delay timer is running This may be accomplished with an electronic governor or other appropriate engine speed control device. In some embodiments, the duration of the stop delay may be adjustable by a user of the pressure washer 10 with a user input device (e.g., a dial, a switch, a button, a touchscreen, etc.). In some embodiments, the stop delay timer is stopped and reset when the user attempts to reinitiate use of the spray gun 20 while the stop delay timer is running (e.g., by squeezing the trigger 58 and/or by engaging one or more of sensors 32 and 34), so that the prime mover 16 is not stopped. Actuating the trigger 53 also takes the pump 18 out of the bypass or recirculation mode and provides pressurized water to the spray gun 20.

The base unit 12 may include a manual override 40. The manual override 40 may include a switch or mechanism that bypasses the control signals from the wireless system 70 to control the pressure washer system 10. In one embodiment, the manual override 40 may include a prime mover control 42. The prime mover control 42 may be configured to activate the prime mover 16 and may include various mechanisms for controlling the prime mover 16, including a start mechanism (e.g., a keyed ignition switch, pushbutton ignition switch, a recoil start, etc.), a throttle mechanism, etc.

The power source 74 is a replaceable or rechargeable power source that provides electrical power to operate the transceiver 76, as well as electronic components on the spray gun 20. According to an exemplary embodiment, the power source 74 is a pair of AA size batteries housed within the handle 26. In one embodiment, the batteries may be replaceable alkaline batteries and the spray gun 20 may include a removable door, allowing a user to access and replace the batteries. In another embodiment, the batteries may be rechargeable batteries (e.g., lithium-ion batteries, nickel-cadmium batteries, etc.), and the spray gun 20 may include an external port coupled to the batteries. A user may recharge the batteries by plugging the port into another power source (e.g., an external charger) or by removing the batteries and recharging or replacing the batteries.

The power source 82 provides power to the wireless system 50, such as the controller 80 and to related electronic components. According to an exemplary embodiment, the power source 82 is an on-board battery, such as a common 12V lead-acid battery mounted on the frame 14 or a rechargeable (e.g., Li-Ion) battery removably mounted to the base unit 12. The power source may be configured to provide power to other components of the pressure washer 10, such as the starter system 15.

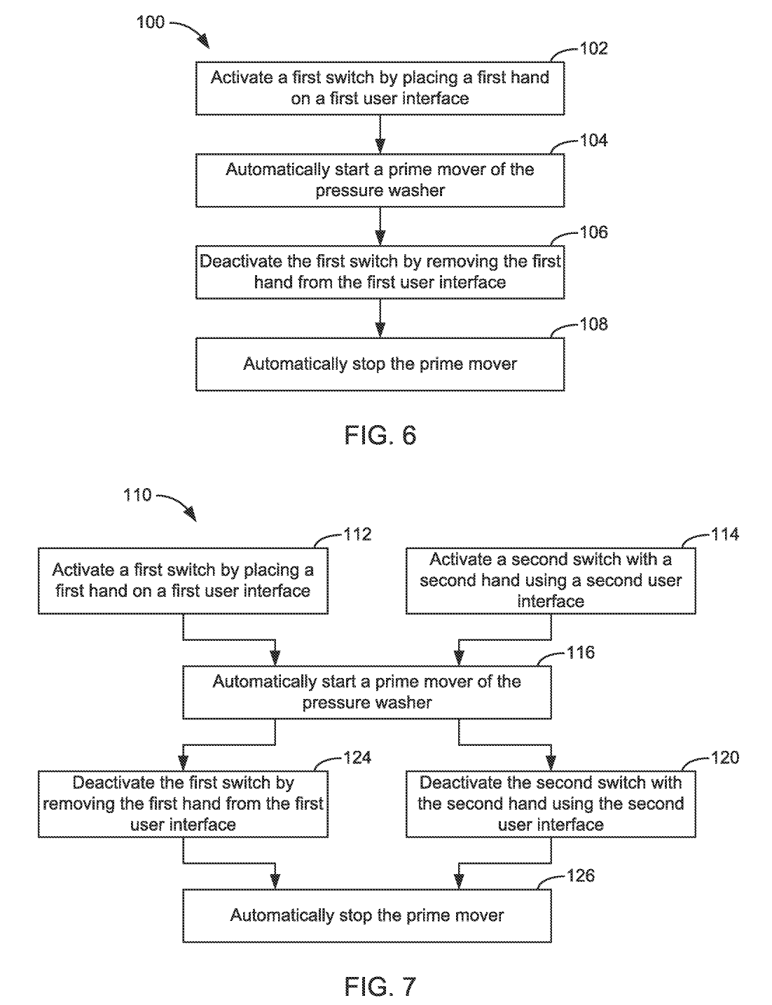

Referring now to FIG. 6, a flowchart illustrates a method 100 for starting a pressure washer with wireless capabilities utilizing a switch (sensor) to detect the presence of a hand on the spray gun. The method includes activating a switch by placing a hand on a grip portion (e.g., a barrel) of a spray gun (step 102) and automatically starting a prime mover of the pressure washer in response to the placement of the hand on the grip portion, thereby causing the prime mover to activate (step 104). The switch, for example, may be a sensor to detect the presence of a hand (e.g., a pressure sensor, capacitive sensor, etc.) or may be another device, such as a trigger sensor to detect the movement of the trigger. The method further includes subsequently deactivating the switch by removing the hand from the grip portion of the spray gun (step 106), and automatically stopping the prime mover in response to the deactivation of the switch (step 108). Stopping the prime mover (step 108) may be delayed by a stop delay timer as discussed above.

Referring now to FIG. 7, a flowchart illustrates a method 110 for starting a pressure washer with wireless capabilities utilizing switches (sensors) to detect the presence of two hands on the spray gun. The method includes activating a first switch by placing a first hand on a first user interface (e.g., a barrel, grip portion, etc.) of a spray gun (step 112). The method further includes activating a second switch with a second hand using a second user interface (e.g., a trigger) of the spray gun (step 114). Each switch, for example, may be a sensor to detect the presence of a hand (e.g., a pressure sensor, capacitive sensor, etc.) or may be another device, such as a trigger sensor to detect the movement of the trigger. A prime mover is automatically started of the pressure washer in response to the placement of the first hand on the first user interface, and a second hand on the second user interface (step 116). The prime mover may be activated in a bypass mode such that pressurized fluid is not provided to the spray gun. The method further includes subsequently deactivating the second switch by removing the second hand from the second user interface of the spray gun (step 120), deactivating the first switch by removing the first hand from the first user interface of the spray gun (step 124), and automatically stopping the prime mover in response to the deactivation of the first switch and the second switch (step 126). Stopping the prime mover (step 126) may be delayed by a stop delay timer as discussed above.

As utilized herein, the terms “approximately,” “about,” “proximate,” “substantially,” and similar terms are intended to have a broad meaning in harmony with the common and accepted usage by those of ordinary skill in the art to which the subject matter of this disclosure pertains. These terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “exemplary” as used herein to describe various embodiments is intended to indicate that such embodiments are possible examples, representations, and/or illustrations of possible embodiments.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the accompanying drawings. The orientation of various elements may differ according to other exemplary embodiments, and that such variations are intended to be encompassed by the present disclosure.

The construction and arrangement of the pressure washer as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pressure washer, comprising:
a prime mover;
a pump driven by the prime mover;
a spray gun fluidly coupled to the pump, the spray gun including a handle with a first grip portion configured to be gripped by a first hand of a user, a barrel including a second grip portion configured to be gripped by a second hand of the user, a flow-control valve movable between an open position and a closed position to control a fluid flow from the spray gun, a user interface configured to be operable by the first hand of the user and to control the flow-control valve such that in a first state of the user interface, the flow-control valve is in the closed position, and in a second state of the user interface, the flow-control valve is in the open position, a presence sensor coupled to the second grip portion and configured to detect the presence of the user's second hand, and a first wireless system electrically coupled to the presence sensor; and
a second wireless system electrically coupled to the prime mover;
wherein the first wireless system transmits a start signal to the second wireless system when the presence sensor detects the presence of the second hand of the user; and
wherein the second wireless system, upon receiving the start signal causes the prime mover to start operation.

2. The pressure washer of claim 1, wherein the second wireless system, upon loss of the start signal causes the prime mover to stop operation.

3. The pressure washer of claim 2, wherein the first wireless system continuously sends the start signal to the second wireless system as long as the presence sensor detects the presence of the user's second hand.

4. The pressure washer of claim 1, wherein the second wireless system, upon loss of the start signal for a predetermined amount of time causes the prime mover to stop operation.

5. The pressure washer of claim 4, further comprising:
a stop delay user input device for varying the predetermined amount of time.

6. The pressure washer of claim 1, wherein the presence sensor comprises a capacitive sensor.

7. The pressure washer or claim 1, further comprising a manual override system including a manual override user input device, wherein with the manual override user input device in a first state, the manual override system causes the prime mover to start operation without regard to the start signal from the first wireless system.

8. The pressure washer of claim 8, wherein, with the manual override user input device in a second state, the manual override system causes the prime mover to stop operation without regard to the start signal from the first wireless system.

9. A pressure washer, comprising:
a prime mover;
a pump driven by the prime mover;
a spray gun fluidly coupled to the pump, the spray gun including a handle with a first grip portion configured to be gripped by a first hand of a user, a barrel including a second grip portion configured to be gripped by a second hand of the user, a flow-control valve movable between an open position and a closed position to control a fluid flow from the spray gun, a user interface configured to be operable by the first hand of the user and to control the flow-control valve such that in a first state of the user interface, the flow-control valve is in the closed position, and in a second state of the user interface, the flow-control valve is in the open position, a first presence sensor coupled to the first grip portion and configured to detect the presence of the user's first hand, a second presence sensor coupled to the second grip portion and configured to detect the presence of the user's second hand, and a first wireless system electrically coupled to the first and second presence sensors; and
a second wireless system electrically coupled to the prime mover;
wherein the first wireless system transmits a start signal to the second wireless system when the first presence sensor detects the presence of the first hand of the user and the second presence sensor detects the presence of the second hand of the user; and
wherein the second wireless system, upon receiving the start signal causes the prime mover to start operation.

10. The pressure washer of claim 9, wherein the second wireless system, upon loss of the start signal causes the prime mover to stop operation.

11. The pressure washer of claim 10, wherein the first wireless system continuously sends the start signal to the second wireless system as long as at least one of the first presence sensor and the second presence sensor detects the presence of one of the user's hands.

12. The pressure washer of claim 9, wherein the second wireless system, upon loss of the start signal for a predetermined amount of time causes the prime mover to stop operation.

13. The pressure washer of claim 12, further comprising:
a stop delay user input device for varying the predetermined amount of time.

14. The pressure washer of claim 9, wherein the second presence sensor comprises a capacitive sensor.

15. The pressure washer or claim 9, further comprising a manual override system including a manual override user input device, wherein with the manual override user input device in a first state, the manual override system causes the prime mover to start operation without regard to the start signal from the first wireless system.

16. The pressure washer of claim 15, wherein, with the manual override user input device in a second state, the manual override system causes the prime mover to stop operation without regard to the start signal from the first wireless system.

17. A pressure washer, comprising:
a prime mover;
a pump driven by the prime mover;
a spray gun fluidly coupled to the pump, the spray gun including:
a handle with a first grip portion configured to be gripped by a first hand of a user,
a barrel including a second grip portion configured to be gripped by a second hand of the user,
a flow-control valve movable between an open position and a closed position to control a fluid flow from the spray gun,
a user interface configured to be operable by the user to control the flow-control valve such that in a first state of the user interface, the flow-control valve is in the closed position, and in a second state of the user interface, the flow-control valve is in the open position,
a presence sensor configured to actuated by the user, and
a spray gun wireless system electrically coupled to the presence sensor; and
a wireless starting system, wherein the spray gun wireless system is configured to transmit a start signal to the wireless starting system of the pressure when the presence sensor is actuated thereby starting the prime mover.

18. The pressure washer of claim 17, wherein the presence sensor is configured to be actuated when the first grip portion is grasped by the user.

19. The pressure washer of claim 17, wherein the presence sensor is configured to be actuated when the second grip portion is grasped by the user.

20. The pressure washer of claim 17, wherein the presence sensor is configured to be actuated by the user interface being in the second state.
